(19) United States
(12) Patent Application Publication
(10) Pub. No.: US 2009/0222480 A1
(43) Pub. Date: Sep. 3, 2009

(54) LOCALIZING OBJECTS IN A PROPERTY STORE

(75) Inventors: George P. Copeland, Kirkland, WA (US); Nima Ganjeh, Redmond, WA (US); Craig Vernon McMurtry, Sammamish, WA (US); Vadim Meleshuk, Seattle, WA (US); Robert D. Ward, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/147,995

(22) Filed: Jun. 27, 2008

Related U.S. Application Data
(60) Provisional application No. 61/032,648, filed on Feb. 29, 2008.

(51) Int. Cl. G06F 17/30

(52) U.S. Cl. 707/103 R; 707/E17.055

(57) ABSTRACT

Managing data for an object, including managing data in the object itself and alternative data applicable to an object dependent on one or more locales. Locales may refer to languages, geographic locations or other user preferences. A first object is stored. The first object includes a first identifier for the first object and a first plurality of properties. The first plurality of properties includes locale invariant values for the first plurality of properties. One or more localized objects are stored. The localized objects are unique from the first object. The localized objects each include a specification of a locale, a related identifier related to the first identifier, and one or more related properties related to one or more of the properties in the first plurality of properties. The related properties store localized values, including one or more alternatives to the locale invariant values particular to the specified locale.

### CROSS-REFERENCE TO RELATED APPLICATIONS

This application claims the benefit of U.S. Provisional Application 61/032,648 titled “LOCALIZING OBJECTS IN A PROPERTY STORE” filed on Feb. 29, 2008, which is incorporated herein by reference in its entirety.

### BACKGROUND

### Background and Relevant Art

Computers and computing systems have affected nearly every aspect of modern living. Computers are generally involved in work, recreation, healthcare, transportation, entertainment, household management, etc.

Computers may include a property store for storing information. Objects in a property store are typically stored in a single locale. For instance, most Chinese employees anglicize their names for storage in the Active Directory® Address Book available from Microsoft Corporation of Redmond Wash., and do not store the Chinese spelling of their name. Some property stores solve this by offering special fields to store localized data, such as one Unicode and one Kanji field for a specific property of an object, such as first name. It is a commonplace requirement to store values for an object in multiple locales, such as an object's property in all localized languages, i.e. English, French, German, Spanish, etc.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment includes a method that may be practiced in a computing environment and includes acts for managing data for an object, including managing data in the object itself and alternative data applicable to an object dependent on one or more locales. The locales refer to one or more of one or more specific geographic locations such as country, a users language preference, and any other special variant preference that a user desires in their user interface, and often including at least a language identifier and a region identifier. The method includes storing a first object. The first object includes a first identifier for the first object and a first plurality of properties for the first object. The first plurality of properties includes locale invariant values for the first plurality of properties. The method further includes storing one or more localized objects. The localized objects are unique from the first object. The localized objects each include a specification of a locale, a related identifier related to the first identifier, and one or more related properties related to one or more of the properties in the first plurality of properties. The related properties store localized values, including one or more alternatives to the locale invariant values particular to the specified locale.

Another embodiment includes a method practiced in a computing environment that includes acts for providing localized objects. The method includes receiving a request to retrieve a localized version of an object. The request includes a first identifier identifying the object and a specification of a locale. The method further includes referencing a first object. The first object includes the first identifier and a first plurality of properties for the first object. The first plurality of properties includes locale invariant values for the first plurality of properties. The method further includes referencing one or more localized objects. The localized objects are unique from the first object. The localized objects each include a specification of a locale, a related identifier related to the first identifier, and one or more related properties related to one or more of the properties in the first plurality of properties. The related properties store localized values, including one or more alternatives to the locale invariant values particular to the specified locale. The method further includes substituting one or more localized values for the locale specified in the request for one or more corresponding locale invariant values to create a localized version of the first object. The localized version of the first object is returned.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an environment including a data store with base objects and localized objects;

FIG. 2 illustrates a method of localizing objects; and

FIG. 3 illustrates an alternate method of localizing objects.

### DETAILED DESCRIPTION

Some embodiments include the ability to create and store in a computer storage for an object a unique but related object for each locale. Each of these unique objects is optional and may only represent a portion of the object in a particular locale. Some embodiments provide for aggregation to combine both localized and locale-invariant properties into a complete object representation. Some embodiments also ensure that the schema of the object is maintained. For instance, if a property of an object is allowed one and only one value for a property, some embodiments will enforce a single value for the property for each of the localized objects. While there may be multiple localized representations of the property, embodiments may be implemented where there is one and only one per locale.

Additionally, some embodiments provide for searching over all localized data. Searching is executed across all localized data, i.e. when searching for object whose property matches a particular query, all localized values for the property are included in the search.

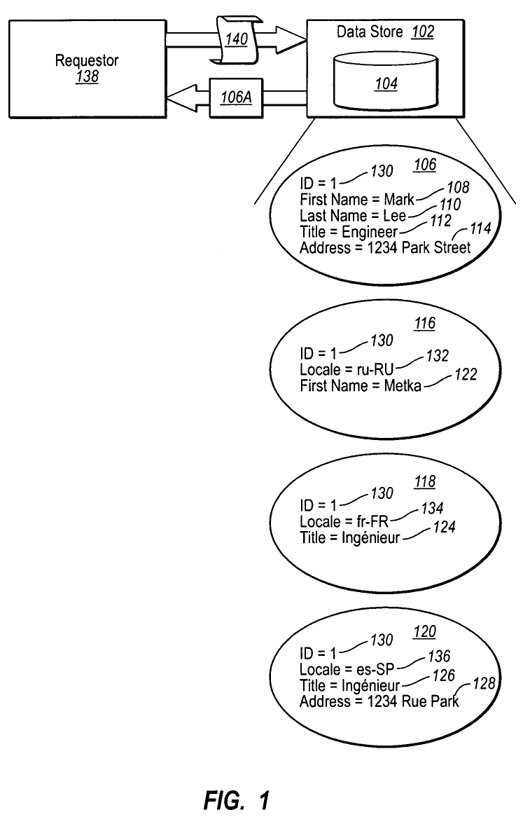

Referring now to FIG. 1, an environment is illustrated. FIG. 1 illustrates a data store 102. The data store 102 includes an object store 104. The object store 104 stores objects. For example, FIG. 1 illustrates a base objet 106. In this example, the base object 106 includes locale invariant values of properties. In this example, the locale invariant object includes a locale invariant value 108 for a first name (i.e. “Mark”), a locale invariant value 110 for a last name (i.e. “Lee”), a locale invariant value 112 for a title (i.e. “Engineer”), and a locale invariant value 114 for an address (i.e. “1234 Park Street”).

As noted previously, some embodiments provide functionality for localization by creating and/or storing a unique but related localized object for each locale. Each of these unique localized objects is optional and may in some embodiments only represent a portion of the object in a particular locale. In particular, in the example shown, three localized objects 116, 118, and 120 are related to the base object 106. A first object 116 is an object localized to Russian language locales and includes a localized value 122 for the First Name property (i.e. “MeTKa”). A second object 118 is an object localized to French speaking locales and includes a localized value 124 for the Title property (i.e. “Ingénieur”). A third object 120 is an object localized to Spanish locales and includes localized values 126 and 128 for a Title property (“Ingeniero”) and an Address property (“1234 rue de Parc”).

Embodiments may provide for one or more unique identifiers for an object that includes a unique ID and, in the case of localized objects, a locale. While each of the localized objects exists at a separate addresses, all related objects may share a common unique ID. For example, the base object 106 includes an identifier property value 130 (i.e. “1”). The same identifier property value 130 is included in each of the localized objects 116, 118, and 120 as well. The localized objects each include a Locale property value as well. Illustratively, the localized object 116 includes a Locale property value 132 indicating that the localized object 116 is a localized object for Russian language locales. The localized object 118 includes a Locale property value 134 indicating that the localized object 118 is a localized object for French language locales. The localized object 120 includes a Locale property 136 indicating that the localized object 120 is a localized object for Spanish language locales.

Some embodiments provide for aggregation to combine both localized property values from localized objects and locale-invariant properties values from the base object 106 into a complete object representation. Some embodiments also ensure that the schema of the object is maintained. For instance, if a property of an object is allowed one and only one value for a property, the method will enforce a single value for the property for each of the localized objects. While there may be multiple localized representations of the property, in the embodiment illustrated, there is one and only one value per locale.

In the embodiment illustrated, when retrieving an object by the unique ID only, a locale invariant representation of the object is returned. When retrieving an object by unique ID and locale, a localized version of the object is returned. Embodiments may provide for returning an object that is constructed from localized values, where available, and locale invariant values to ensure that the object conforms to a schema.

When creating or updating an object, some embodiments allow for optionally specifying a single locale into which all the submitted values will be stored as part of the unique identifier. A create or update operation is subject to all schema validation, within the scope of the specified locale, regardless of the values stored in separate locales. Examples of this mechanism follow.

The following illustrates a Person Object, such as the base object 106 with values:

ID=1

First Name=Mark (locale invariant)

Last Name=Lee (locale invariant)

Title=Engineer (local invariant)

Address: 1234 Park Street (local invariant)

An update operation may be performed to create a localized object, such as localized object 116, with the following values:

ID=1

Locale=ru-RU (Russian)

First Name MeTKa

Another update operation may be performed to create a localized object, such as localized object 118, with the following values:

ID=1

Locale=fr-FR (French)

Title: Ingénieur

A GET operation may be performed to retrieve a localized version of the base object 106 localized to Russian language locales. For example, FIG. 1 illustrates a requester 138 sending a request 140. The request 140 may be as follows:

### Get:

ID=1

Locale=ru-RU (Russian)

As a result, the data store 102 returns a localized version 106A of the base object 106 with the following values:

ID=1

First Name MeTKa (Russian)

Last Name=Lee (locale invariant)

Title=Engineer (local invariant)

Address: 1234 Park Street (local invariant)

In an alternative example a GET operation may be performed to retrieve a localized version of the base object 106 localized to French language locales. For example, FIG. 1 illustrates a requester 138 sending a request 140. The request 140 may be as follows:

### Get:

ID=1

Locale=fr-FR (French)

As a result, the data store 102 returns a localized version 106A of the base object 106 with the following values:

ID=1

First Name=Mark (locale invariant)

Last Name=Lee (locale invariant)

Title: Ingénieur (French)

Address: 1234 Park Street (local invariant)

Note that in the preceding examples, and in the examples the follow, indications of a locale, or an indication that a value is locale invariant is included in parenthesis for understanding. The actual values do not need to include the indication of locale or the indication that a value is locale invariant. It should be noted however, that even though not required, embodiments may be implemented where an identifier is included with the value to indicate locale or to indicate locale invariance.

Some embodiments provide for searching over all localized data. Searching may be executed across all localized data, i.e. when searching for object whose property value matches a particular query, all localized values for the property can be included in the search.

Embodiments may provide for searching and specifying objects in multiple locales, each locale with a precedence value. When returned, the objects will be constructed from the requested locales by combining values, in precedent order, from each specified locale and the locale invariant values. For instance, when querying for person objects with locale precedence of French, German, Spanish, each matching object will be returned with all French values where present, all German values where present but French were not, all Spanish values where present and French and German were not and all remaining values from the a locale invariant object. Examples of this mechanism are as follows:

The following illustrates a Person Object, such as the base object 106 with values:

ID=1

First Name=Mark (locale invariant)

Last Name=Lee (locale invariant)

Title=Engineer (local invariant)

Address: 1234 Park Street (local invariant)

An update operation may be performed to create a localized object, such as localized object 116, with the following values:

ID=1

Locale=ru-RU (Russian)

First Name MeTKa

Another update operation may be performed to create a localized object, such as localized object 118, with the following values:

ID=1

Locale=fr-FR (French)

Title: Ingénieur

Yet another update operation may be performed to create a localized object, such as localized object 120, with the following values:

ID=1

Locale=es-SP (Spanish)

Title: Ingeniero

Address: 1234 rue de Parc

A request 140 from a requester 138 may include a query specifying the following:

ID=1

Locale(s)=ru-RU (Russian), fr-FR (French), es-SP (Spanish)

As a result, the data store 102 returns a localized version 106A of the base object 106 with the following values:

ID=1

First Name MeTKa (Russian)

Last Name=Lee (locale invariant)

Title: Ingénieur (French)

Address: 1234 rue de Parc (Spanish)

However, because each localized object is a unique object, embodiments may also provide for searching and specifying objects in multiple locales and returning one for each locale. Examples of this mechanism are as follows:

The following illustrates a Person Object, such as the base object 106 with values:

ID=1

First Name=Mark (locale invariant)

Last Name=Lee (locale invariant)

Title=Engineer (local invariant)

Address: 1234 Park Street (local invariant)

An update operation may be performed to create a localized object, such as localized object 116, with the following values:

ID=1

Locale=ru-RU (Russian)

First Name MeTKa

Another update operation may be performed to create a localized object, such as localized object 118, with the following values:

ID=1

Locale=fr-FR (French)

Title: Ingénieur

Yet another update operation may be performed to create a localized object, such as localized object 120, with the following values:

ID=1

Locale=es-SP (Spanish)

Title: Ingeniero

Address: 1234 rue de Parc

A request 140 from a requester 138 may include a query specifying the following:

ID=1

Locale(s)=ru-RU (Russian), fr-FR (French), es-SP (Spanish)

As a result, the data store 102 returns a localized versions of the base object 106 with the following values:

ID=1

Locale=ru-RU

First Name MeTKa (Russian)

Last Name=Lee (locale invariant)

Title=Engineer (local invariant)

Address: 1234 Park Street (local invariant)

ID=1

Locale=fr-FR

First Name=Mark (locale invariant)

Last Name=Lee (locale invariant)

Title: Ingénieur (French)

Address: 1234 Park Street (local invariant)

ID=1

Locale=es-SP

First Name=Mark (locale invariant)

Last Name=Lee (locale invariant)

Title: Ingeniero (Spanish)

Address: 1234 rue de Parc (Spanish)

Some embodiments can be practiced using Web Service protocols: WS-Addressing, WS-Transfer, and WS-Enumeration. To implement embodiments within these protocols, the following extensions may be applied to the existing protocols:

### WS-Addressing:

Locale Reference property: A value indicating a specific locale for the object. This element is optional; if no locale is present, the invariant object is represented. This value determines who Create, Update and Get Requests are processed.

Example: The object whose Object ID is 03CED96B-BE01-4C18-95A5-FCD2FAA09C25 presented in a United Kingdom representation.

```
<wsa:ReferenceProperties>
  <rm:ResourceReferenceProperty>
  03CED96B-BE01-4C18-95A5-FCD2FAA09C25
  </rm:ResourceReferenceProperty>
  <rm:Locale>
  en-UK
  </rm:Locale>
</wsa:ReferenceProperties>
```

Example: Retrieve a Group localized in French using WS-Transfer

```
<s:Envelope
  xmlns:s=“http://www.w3.org/2003/05/soap-envelope”
  xmlns:wsa=“http://schemas.xmlsoap.org/ws/2004/08/addressing”
xmlns:rm=“http://schemas.microsoft.com/2006/11/
ResourceManagement”>
  <s:Header>
  <wsa:ReplyTo>
    <wsa:Address>
    http://www.woodgrove.com/sender
    </wsa:Address>
  </wsa:ReplyTo>
  <wsa:To>
http://www.woodgrove.com:5725/ResourceManagementService/Resource
    </wsa:To>
<rm:IdentityObjectReferencePropertyResourceReferenceProperty>
    03CED96B-BE01-4C18-95A5-FCD2FAA09C25
</rm:IdentityObjectReferencePropertyResourceReferenceProperty>
  <rm:Locale>
    fr-FR
  </rm:Locale>
  <wsa:Action>
    http://schemas.xmlsoap.org/ws/2004/09/transfer/Get
  </wsa:Action>
  <wsa:MessageID>
    uuid:00000000-0000-0000-C000-000000000046
  </wsa:MessageID>
  <rm:ResourceManagement s:mustUnderstand=“true”/>
  </s:Header>
  <s:Body>
  </s:Body>
</s:Envelope>
```

Example: Update a Group localized in French using WS-Transfer

```
<s:Envelope
  xmlns:s=“http://www.w3.org/2003/05/soap-envelope”
  xmlns:wsa=“http://schemas.xmlsoap.org/ws/2004/08/addressing”
xmlns:rm=“http://schemas.microsoft.com/2006/11/
ResourceManagement”>
  <s:Header>
  <wsa:ReplyTo>
    <wsa:Address>
    http://www.woodgrove.com/sender
    </wsa:Address>
  </wsa:ReplyTo>
  <wsa:To>
http://www.woodgrove.com:5725/ResourceManagementService/Resource
  </wsa:To>
<rm:IdentityObjectReferencePropertyResourceReferenceProperty>
    03CED96B-BE01-4C18-95A5-FCD2FAA09C25
</rm:IdentityObjectReferencePropertyResourceReferenceProperty>
  <rm:Locale>
    fr-FR
  </rm:Locale>
  <wsa:Action>
    http://schemas.xmlsoap.org/ws/2004/09/transfer/Put
  </wsa:Action>
  <wsa:MessageID>
    uuid:00000000-0000-0000-C000-000000000046
  </wsa:MessageID>
  <rm:ResourceManagement s:mustUnderstand=“true”/>
  </s:Header>
  <s:Body>
  <rm:Group>
    ...
  </rm:Group>
  </s:Body>
</s:Envelope>
```

### WS-Enumeration:

LocalePreferences Element: As an extension to WS-Enumeration, a client can request to retrieve a collection of objects localized. This element contains a collection of locales, each specified by a LocalePreference element, which contains a Locale element, specifying the desired locale, and a Preference Value element, which is a positive integer that specifies the preference order where 0 is the highest preference. When specified, the results will include a single object that matched the search criteria with property values included in the order of preferred languages. For instance, if one were to ask for the localized version of a person with locale precedence of French, German, Spanish, the object will be returned with all French values where present, all German values where present but French were not, all Spanish values where present and French and German were not and all remaining values in a locale invariant form. This parameter is optional; the lack of the parameter is interpreted by the Identity Object Management services as “return a collection objects in a locale invariant representation”.

Example: a WS-Enumeration Enumerate request objects to be returned in Russian, French and Spanish:

```
<s:Envelope
  xmlns:s=‘http://www.w3.org/2003/05/soap-envelope’
  xmlns:wsa=‘http://schemas.xmlsoap.org/ws/2004/08/addressing’
  xmlns:wsen=‘ http://schemas.xmlsoap.org/ws/2004/09/enumeration’
xmlns:rm=‘http://schemas.microsoft.com/2006/11/ResourceManagement’>
  <s:Header>
  <wsa:ReplyTo>
    <wsa:Address>
        http://www.woodgrove.com/sender
  </wsa:Address>
  </wsa:ReplyTo>
  <wsa:To>
http://www.woodgrove.com:5725/ResourceManagementService/
Enumeration
  </wsa:To>
  <wsa:Action>
    http://schemas.xmlsoap.org/ws/2004/09/enumeration/Enumerate
  </wsa:Action>
  <wsa:MessageID>
    uuid:00000000-0000-0000-C000-000000000046
  </wsa:MessageID>
  </s:Header>
  <s:Body>
  <wsen:Enumerate>
    <wsen:Filter
Dialect=’http://schemas.microsoft.com/2006/11/XPathFilterDialect’>
    /*/*/rm:Group
    </wsen:Filter>
    <rm:LocalePreferences >
    <rm:LocalePreference >
      <rm:Locale >ru-RU</rm:Locale>
      <rm: PreferenceValue>1</rm: PreferenceValue>
    </rm:LocalePreference >
    <rm:LocalePreference >
      <rm:Locale >fr-FR</rm:Locale>
      <rm: PreferenceValue>2</rm: PreferenceValue>
    </rm:LocalePreference >
    <rm:LocalePreference >
      <rm:Locale >es-SP</rm:Locale>
      <rm: PreferenceValue>3</rm: PreferenceValue>
    </rm:LocalePreference >
    </rm:LocalePreferences >
  </wsen:Enumerate>
  </s:Body>
</s:Envelope>
```

The following discussion now refers to a number of methods and method acts that may be performed. It should be noted, that although the method acts may be discussed or shown in the Figures in a certain order, no particular ordering is necessarily required unless specifically stated, or required because an act is dependent on another act being completed prior to the act being performed.

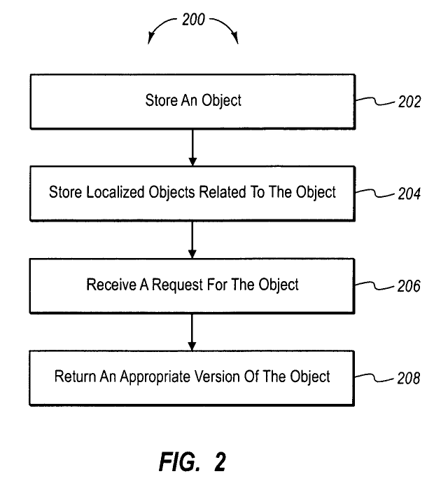

Referring now to FIG. 2, a method 200 is illustrated. The method 200 may be practiced in a computing environment. The method 200 includes acts for managing data for an object, including managing data in the object itself and alternative data applicable to an object dependent a locale. The locale refers to one or more specific geographic locations. The method 200 includes storing a first object (act 202). The first object includes a first identifier for the first object and a first plurality of properties for the first object. The first plurality of properties includes locale invariant values for the first plurality of properties. For example, FIG. 1 illustrates an object 106 that includes a number of locale invariant properties, as discussed previously herein. Such locale invariant properties include a locale invariant value 108 for a first name (i.e. “Mark”), a locale invariant value 110 for a last name (i.e. “Lee”), a locale invariant value 112 for a title (i.e. “Engineer”), and a locale invariant value 114 for an address (i.e. “1234 Park Street”).

The method 200 further includes storing one or more localized objects (act 204). The localized objects are unique from the first object. The localized objects each include a specification of a locale, a related identifier related to the first identifier, and one or more related properties related to one or more of the properties in the first plurality of properties. The related properties store localized values, including one or more alternatives to the locale invariant values, where the localized values are particular to the specified locale. For example, FIG. 1 illustrates a number of localized objects 116, 118, and 120. The first object 116 is an object localized to Russian language locales and includes a localized value 122 for the First Name property (i.e. “MeTKa”). A second object 118 is an object localized to French speaking locales and includes a localized value 124 for the Title property (i.e. “Ingénieur”). A third object 120 is an object localized to Spanish locales and includes localized values 126 and 128 for a Title property (“Ingeniero”) and an Address property (“1234 rue de Parc”). Each of the localized objects 116, 118, and 120 include the identifier 130, which is also included in the object 106. Thus, as used herein, including a related identifier may include including the identifier itself. In some embodiments, the first identifier and the related identifier may include distinct information, but also include a common value.

The method 200 further includes receiving a request to retrieve the first object (act 206). The method 200 also includes, in response to the request, returning the first object (act 208). These two acts may be performed in various ways. For example, in one embodiment, when receiving a request to retrieve the first object (act 206) the request includes the first identifier and does not include a specification of a locale. In this embodiment, the act of returning the first object (act 208) includes returning the first object without returning property values from any of the one or more localized objects. For example, in FIG. 1, the request 140 may identify the first object 106, but not identify any locales. In this case, instead of a localized object 106A being returned, the base object 106 is returned without any substitutions of property values.

In an alternative embodiment, receiving a request to retrieve the first object (act 206) is performed such that the request includes the first identifier and a specification of a locale. In response to the request, returning the first object (act 208) includes returning a localized version of the first object with one or more localized values from one or more of the localized objects for the locale specified in the request being substituted for one or more corresponding locale invariant values. For example, in FIG. 1, the request 140 may request the object 106 and include specification of one or more locales. As described previously, localized values can be substituted for the locale invariant values to facilitate returning of the localized object 106A. In some embodiments, this may facilitate returning localized versions of the first object that conform to a schema for the first object. In one particular example, the schema for the object 106 may only include provisions for single values for the first name property, the last name property, the title property, or the address property. Thus, by substituting a localized value for a locale invariant value, the localized object 106A can still conform to a schema for the base object 106.

In yet another alternative embodiment, receiving a request for the object (act 206) may be substituted for or may be accomplished by receiving a search request for a search value. In response to the search request, the method 200 may include searching the first object and one or more of the one or more localized objects for the search value. Additionally, results may be returned by returning an appropriate version of the object (act 208) with search results included in the object. This may be accomplished by returning an object with locale invariant values if appropriate, and/or localized values substituted if appropriate. For example, if a search is performed for “Mark”, the base object 106 may be returned. If a search is performed for “MeTKa”, a localized object 106A with the value 122 substituted for the value 108 may be returned. If a search is performed for “Mark” and “Ingénieur”, a localized object 106A may be returned where the value 108 remains from the base object 106, but the value 124 is substituted for the value 112. If a search is performed for “MeTKa” and “Ingénieur”, a localized object 106A with value 122 substituted for value 108 and value 124 substituted for value 112 may be returned.

Some searching embodiments may be implemented where different corresponding localized or locale invariant values are searched for in the same search. These searches may be handled in a number of different ways. In some embodiments, a single object with all alternatives may be returned. For example, a search for “Mark” or “MeTKa” may result in an object being returned that includes values 108 and 122 for the First Name parameter. However, this embodiment does not necessarily allow for a particular schema to be complied with.

In another embodiment, multiple objects may be returned with the different values. For example, a search for “Mark” or “MeTKa” may result in two objects being returned, namely the base object 106 and a localized object 106A with the value 122 substituted for the value 108 in the name parameter.

In some embodiments, receiving a request for the first object (act 206) may be performed such that the request includes a specification of precedence for locales. In response to the request, returning an appropriate version of the object (act 208) may include returning the first object with localized values substituted for the locale invariant values according to the specification of precedence such that localized objects for locales with higher precedence have their values substituted before localized objects for locales with lower precedence. Further, a localized value for a locale with lower precedence, in some embodiments, only has localized values substituted if there are no corresponding localized values for localized objects for locales with higher precedence.

In some embodiments, receiving a request for the object (act 206) may include receiving a request for a plurality of locale specific objects where the request includes a specification of a plurality of locales for the locale specific objects. In response to the request, returning an appropriate version (act 208) may actually include returning a plurality of local specific objects, including a locale specific object for each of the locales specified in the request. Each of the locale specific objects may be created by using the first object with localized values substituted for the locale invariant values according to the specification of locales. For example, if a request 140 specified the base object 106 and locales ru-RU, fr-FR and es-SP, then three different localized objects 106A would be returned the first substituting values from localized object 116, the second substituting values from localized object 118, and the third substituting values from localized object 120 as appropriate.

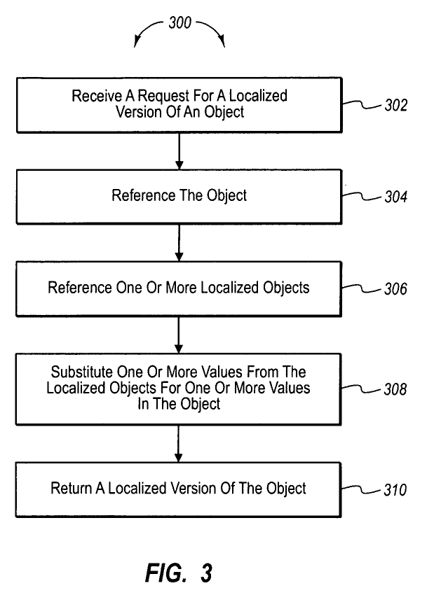

Referring now to FIG. 3, another embodiment is illustrated as a method 300. The method 300 may be practiced in a computing environment, and includes method acts for providing localized objects. The method includes receiving a request to retrieve a localized version of an object (act 302). The request includes a first identifier identifying the object and a specification of a locale. For example, as illustrated previously, a request may include the identifier 130 and one or more specifications of locale, such as ru-RU for Russian, fr-FR for French, or es-SP for Spanish.

A first object is referenced (act 304). The first object the first identifier and a first plurality of properties for the first object. The first plurality of properties including locale invariant values for the first plurality of properties. An example of this object is object 106 illustrated in FIG. 1.

The method 300 further includes referencing one or more localized objects (act 306). The localized objects are unique from the first object. The localized objects each include a specification of a locale, a related identifier related to the first identifier, and one or more related properties related to one or more of the properties in the first plurality of properties. The related properties store localized values, including one or more alternatives to the locale invariant values particular to the specified locale. Examples of localized objects include objects 116, 118, and 120 illustrated in FIG. 1.

The method 300 further includes substituting one or more localized values for the locale specified in the request for one or more corresponding locale invariant values (act 308) to create a localized version of the first object. Object 106A illustrates a localized version of the first object 106 in FIG. 1.

The method 300 further includes returning the localized version of the first object (act 310).

Embodiments of the present invention may comprise or utilize a special purpose or general-purpose computer including computer hardware. For example, the requester 138 and the data store 102 may be implemented using computing system comprising appropriate hardware and/or software including processors, memory, storage, operating systems, application software or other hardware or software. Additionally components may be implemented on each their own separate stand-alone computer system including individualized hardware where the machines are interconnected through network communication channels or other communication channels. Alternatively, components may be implemented on a common shared computer system, where the machines share resources, such as processor resources, memory resources, storage resources, or other resources.

Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of managing data for an object, including managing data in the object itself and alternative data applicable to an object dependent on one or more locales, the locales referring to at least one of one or more specific geographic locations or a language, the method comprising:
storing a first object comprising:
a first identifier for the first object; and
a first plurality of properties for the first object, the first plurality of properties including locale invariant values for the first plurality of properties;
storing one or more localized objects, the localized objects being unique from the first object, the localized objects each comprising:
a specification of a locale;
a related identifier related to the first identifier; and
one or more related properties related to one or more of the properties in the first plurality of properties, wherein the related properties store localized values, comprising one or more alternatives to the locale invariant values particular to the specified locale.

2. The method of claim 1, wherein the first identifier and the related identifier comprise a common value.

3. The method of claim 1, wherein the related identifier comprises an indication of the specified locale.

4. The method of claim 1, further comprising:
receiving a request to retrieve the first object, the request including the first identifier and not including a specification of a locale; and
in response to the request, returning the first object without returning property values from any of the one or more localized objects.

5. The method of claim 1, further comprising:
receiving a request to retrieve the first object, the request including the first identifier and a specification of a locale; and
in response to the request, returning a localized version of the first object with one or more localized values from one or more of the localized objects for the locale specified in the request being substituted for one or more corresponding locale invariant values.

6. The method of claim 5, wherein the localized version of the first object conforms to a schema for the first object.

7. The method of claim 1, further comprising:
receiving a search request for a search value; and
in response to the request, searching the first object and one or more of the one or more localized objects for the search value.

8. The method of claim 1, further comprising:
receiving a request for the first object, the request comprising a specification of precedence for locales; and
in response to the request, returning the a localized version of the first object with localized values substituted for the locale invariant values according to the specification of precedence such that localized objects for locales with higher precedence have their values substituted before localized objects for locales with lower precedence and wherein a localized value for a locale with lower precedence only has localized values substituted if there are no corresponding localized values for localized objects for locales with higher precedence.

9. The method of claim 1, further comprising:
receiving a request for a plurality of locale specific objects, the request comprising a specification of a plurality of locales for the locale specific objects; and
in response to the request, returning a plurality of local specific objects, including a locale specific object for each of the locales specified in the request, each of the locale specific objects being created by using the first object with localized values substituted for the locale invariant values according to the specification of locales.

10. The method of claim 1, wherein one or more of the one or more localized objects include related properties related to the one or more properties in the first plurality of properties for less than all of the first plurality of properties.

11. In a computing environment, a method of providing localized objects, the method comprising:
receiving a request to retrieve a localized version of an object, the request including a first identifier identifying the object and a specification of a locale;
referencing a first object, the first object comprising:
the first identifier; and
a first plurality of properties for the first object, the first plurality of properties including locale invariant values for the first plurality of properties;
referencing one or more localized objects, the localized objects being unique from the first object, the localized objects each comprising:
a specification of a locale;
a related identifier related to the first identifier; and
one or more related properties related to one or more of the properties in the first plurality of properties, wherein the related properties store localized values, comprising one or more alternatives to the locale invariant values particular to the specified locale; and
substituting one or more localized values for the locale specified in the request for one or more corresponding locale invariant values to create a localized version of the first object; and
returning the localized version of the first object.

12. The method of claim 11, wherein the related identifier and the first identifier comprise a common value.

13. The method of claim 11, wherein the related identifier is the first identifier.

14. The method of claim 11, wherein the localized version of the first object conforms to a schema for the first object.

15. The method of claim 11, wherein receiving a request to retrieve a localized version of an object comprises receiving a search request including one or more search values included as one or more localized value in one or more of the localized objects.

16. The method of claim 11, wherein receiving a request to retrieve a localized version of an object comprises receiving a request indicating a precedence for one or more locales

17. In a computing environment, a computer readable medium comprising computer executable instructions that when executed by a processor are configured to perform the following:
storing a first object comprising:
a first identifier for the first object; and
a first plurality of properties for the first object, the first plurality of properties including locale invariant values for the first plurality of properties;
storing one or more localized objects, the localized objects being unique from the first object, the localized objects each comprising:
a specification of a locale;
a related identifier related to the first identifier; and
one or more related properties related to one or more of the properties in the first plurality of properties, wherein the related properties store localized values, comprising one or more alternatives to the locale invariant values particular to the specified locale.
receiving a request to retrieve the first object, the request including the first identifier and a specification of a locale; and
in response to the request, returning a localized version of the first object with one or more localized values from one or more of the localized objects for the locale specified in the request being substituted for one or more corresponding locale invariant values, the localized version of the first object conforming to the schema for the first object.

18. The method of claim 17, wherein the localized version of the first object conforms to a schema for the first object.

19. The method of claim 17, wherein receiving a request to retrieve the first object comprises receiving a search request including one or more search values included as one or more localized value in one or more of the localized objects.

20. The method of claim 17, wherein receiving a request to retrieve the first object comprises receiving a request indicating a precedence for one or more locales.
